(19) United States
(12) Patent Application Publication
(10) Pub. No.: US 2007/0257878 A1
(43) Pub. Date: Nov. 8, 2007

(54) Light source device for video display, and related method

(75) Inventor: Naoyuki Tanaka, Kanagawa-ken (JP)

Correspondence Address: LOUIS WOO;LAW OFFICE OF LOUIS WOO, 717 NORTH FAYETTE STREET, ALEXANDRIA, VA, 22314, US

(73) Assignee: Victor Company of Japan, Ltd., Yokohama (JP)

(21) Appl. No.: 11/727,858

(22) Filed: Mar. 28, 2007

(30) Foreign Application Priority Data
Apr. 24, 2006 (JP) 2006-119004

(51) Int. Cl. G09G 3/36

(52) U.S. Cl. 345/99

(57) ABSTRACT

First, second, and third light sources serve to emit light having three primary colors, respectively. The first light source is activated by a first drive pulse which has a first width and which repetitively occurs at a specified frequency. The second light source is activated by a second drive pulse which has a second width and which repetitively occurs at the specified frequency. The third light source is activated by a third drive pulse which has a third width greater than the first and second widths and which repetitively occurs at the specified frequency. Time positions of front edges of the first, second, and third drive pulses are different. The first drive pulse occupies a time range contained in a time range for which the third drive pulse extends. The second drive pulse occupies a time range contained in the time range for which the third drive pulse extends.

### BACKGROUND OF THE INVENTION

1. Field of the Invention

This invention relates to a light source device for a video display. In addition, this invention relates to a method of driving a light source device for a video display.

2. Description of the Related Art

Some video displays include a back light formed by a light source device composed of red (R), green (G), and blue (B) light sources. It is known to use LEDs (light emitting diodes) for a back light. Usually, a red LED array, a green LED array, and a blue LED array constitute a back light.

In conventional back lights, LEDs are driven by pulse signals respectively, and the intensities of light emitted from the LEDs are adjusted by controlling the pulse widths, the pulse numbers, or the pulse voltages (the pulse heights) concerning the pulse signals.

Japanese patent application publication number 2004-333576 discloses a light source unit for a picture display. The light source unit in Japanese application 2004-333576 includes red, green, and blue LED arrays which are driven by pulse signals. The pulse widths concerning the pulse signals can be changed. According to a first example, the activations of the red, green, and blue LED arrays are on a time sharing basis. According to a second example, the moments of start of every activation of the red and green LED arrays are the same and are preceded by the moment of start of corresponding activation of the blue LED array, and the moments of end of every activation of the green and blue LED arrays are the same and are followed by the moment of end of corresponding activation of the red LED array. In the second example, there are a time range for which all the red, green, and blue LED arrays are activated, a time range for which only the blue LED array is activated, and a time range for which only the red LED array is activated. In the second example, the time range of every other activation of the green LED array is contained in the time rage during which the red LED array is activated and the time range during which the blue LED array is activated.

In general, red, green, and blue LEDs are different in light emission efficiency. Specifically, the light emission efficiency of the blue LED is lower than those of the red and green LEDs. Accordingly, in the case where the red, green, and blue LEDs are driven by same-frequency same-amplitude pulse signals respectively and the intensities of light emitted therefrom are required to be equal, it is necessary that the pulse width concerning the pulse signal for the blue LED is greater than those concerning the pulse signals for the red and green LEDs. In this case, the blue LED continues to be activated to emit light for every time interval longer than those during which the red and green LEDs remain activated. Such extra-time light emission from the blue LED may cause color breaking when the frequency of the pulse signals is in a certain range. The color breaking means a phenomenon in which non-existent color is observed in an outline of an image indicated by a display, or the tone of an image portion is seen as separate colors.

Japanese patent application publication number 2001-174782 discloses a color display including a liquid-crystal display panel and a back light. In Japanese application 2001-174782, the back light uses a fluorescent lamp designed to emit light having at least two of red, green, and blue components. The liquid-crystal display panel and the back light are driven by pulse signals respectively. To control a color tone of light outputted through the liquid-crystal display panel, the phase difference between the pulse signals is adjusted. Japanese application 2001-174782 teaches that the back light may use LEDs instead of the fluorescent lamp.

### SUMMARY OF THE INVENTION

It is an object of this invention to provide a light source device for a video display which suppresses color breaking.

It is another object of this invention to provide a method of driving a light source device for a video display which suppresses color breaking.

A first aspect of this invention provides a method of driving a light source device for a video display. The light source device includes a first light source for emitting light having a first primary color, a second light source for emitting light having a second primary color different from the first primary color, and a third light source for emitting light having a third primary color different from the first and second primary colors. The method comprises the steps of activating the first light source by a first drive pulse which has a first width and which repetitively occurs at a specified frequency; activating the second light source by a second drive pulse which has a second width and which repetitively occurs at the specified frequency; and activating the third light source by a third drive pulse which has a third width greater than the first and second widths and which repetitively occurs at the specified frequency. Time positions of front edges of the first, second, and third drive pulses are different. The first drive pulse occupies a time range contained in a time range for which the third drive pulse extends, and the second drive pulse occupies a time range contained in the time range for which the third drive pulse extends.

A second aspect of this invention is based on the first aspect thereof, and provides a method wherein time positions of centers of the first, second, and third drive pulses are equal.

A third aspect of this invention is based on the first aspect thereof, and provides a method wherein time positions of rear edges of the first, second, and third drive pulses are different.

A fourth aspect of this invention provides a light source device for a video display which comprises a first light source for emitting light having a first primary color; a second light source for emitting light having a second primary color different from the first primary color; a third light source for emitting light having a third primary color different from the first and second primary colors; means for activating the first light source by a first drive pulse which has a first width and which repetitively occurs at a specified frequency; means for activating the second light source by a second drive pulse which has a second width and which repetitively occurs at the specified frequency; and means for activating the third light source by a third drive pulse which has a third width greater than the first and second widths and which repetitively occurs at the specified frequency. Time positions of front edges of the first, second, and third drive pulses are different. The first drive pulse occupies a time range contained in a time range for which the third drive pulse extends, and the second drive pulse occupies a time range contained in the time range for which the third drive pulse extends.

A fifth aspect of this invention is based on the fourth aspect thereof, and provides a light source device wherein time positions of centers of the first, second, and third drive pulses are equal.

A sixth aspect of this invention is based on the fourth aspect thereof, and provides a light source device wherein time positions of rear edges of the first, second, and third drive pulses are different.

A seventh aspect of this invention is based on the fourth aspect thereof, and provides a light source device wherein each of the first, second, and third light sources comprises an array of LEDs.

An eighth aspect of this invention provides a method of driving a back light device for a liquid-crystal display. The back light device includes a first light source for emitting light having a first color, and a second light source for emitting light having a second color different from the first color. The method comprises the steps of activating the first light source by a first drive pulse which has a first width and which repetitively occurs at a specified frequency; and activating the second light source by a second drive pulse which has a second width greater than the first width and which repetitively occurs at the specified frequency; wherein time positions of front edges of the first and second drive pulses are different, and time positions of rear edges of the first and second drive pulses are different, and wherein the first drive pulse occupies a time range contained in a time range for which the second drive pulse extends.

A ninth aspect of this invention is based on the eighth aspect thereof, and provides a method wherein each of the first and second light sources comprises an array of LEDs.

A tenth aspect of this invention is based on the eighth aspect thereof, and provides a method wherein time positions of centers of the first and second drive pulses are equal.

An eleventh aspect of this invention provides a back light device for a liquid-crystal display. The back light device comprises a first light source for emitting light having a first color; a second light source for emitting light having a second color different from the first color; means for activating the first light source by a first drive pulse which has a first width and which repetitively occurs at a specified frequency; and means for activating the second light source by a second drive pulse which has a second width greater than the first width and which repetitively occurs at the specified frequency; wherein time positions of front edges of the first and second drive pulses are different, and time positions of rear edges of the first and second drive pulses are different, and wherein the first drive pulse occupies a time range contained in a time range for which the second drive pulse extends.

A twelfth aspect of this invention is based on the eleventh aspect thereof, and provides a back light device wherein each of the first and second light sources comprises an array of LEDs.

A thirteenth aspect of this invention is based on the eleventh aspect thereof, and provides a back light device wherein time positions of centers of the first and second drive pulses are equal.

This invention has advantages indicated below. Since the time positions of the front edges of the first, second, and third drive pulses are different, the sum of the electric powers consumed by the first, second, and third light sources gradually increases to the maximum value. Therefore, the load applied to a power supply for the first, second, and third light sources gradually increases to the maximum level. Basically, such a gradually-increasing applied load is acceptable to the power supply. In the case where the time positions of the rear edges of the first, second, and third drive pulses are different, it is possible to suppress observable color breaking in an image indicated by the video display.

### BRIEF DESCRIPTION OF THE DRAWINGS

FIG. 1 is a block diagram of a video display including a back light device according to a first embodiment of this invention.

FIG. 2 is a time-domain diagram showing a first example of the waveforms of a vertical sync signal, and PWM signals for driving red, green, and blue LED arrays in FIG. 1.

FIG. 3 is a time-domain diagram showing a second example of the waveforms of the vertical sync signal and the PWM signals.

FIG. 4 is a time-domain diagram showing variations in the electric powers consumed by the red, green, and blue LED arrays, the sum of the consumed electric powers, the luminance provided by the light applied from the back light device to a display panel in FIG. 1, and the color of the light applied from the back light device to the display panel which occur in the case where the waveforms of the vertical sync signal and the PWM signals, and the phase relation thereamong are in the conditions of FIG. 3.

FIG. 5 is a time-domain diagram showing a third example of the waveforms of the vertical sync signal and the PWM signals.

FIG. 6 is a time-domain diagram showing variations in the electric powers consumed by the red, green, and blue LED arrays, the sum of the consumed electric powers, the luminance provided by the light applied from the back light device to the display panel in FIG. 1, and the color of the light applied from the back light device to the display panel which occur in the case where the waveforms of the vertical sync signal and the PWM signals, and the phase relation thereamong are in the conditions of FIG. 5.

FIG. 7 is a time-domain diagram showing the third example of the waveforms of the PWM signals.

FIG. 8 is a time-domain diagram showing a fourth example of the waveforms of the vertical sync signal and the PWM signals.

### DETAILED DESCRIPTION OF THE INVENTION

### First Embodiment

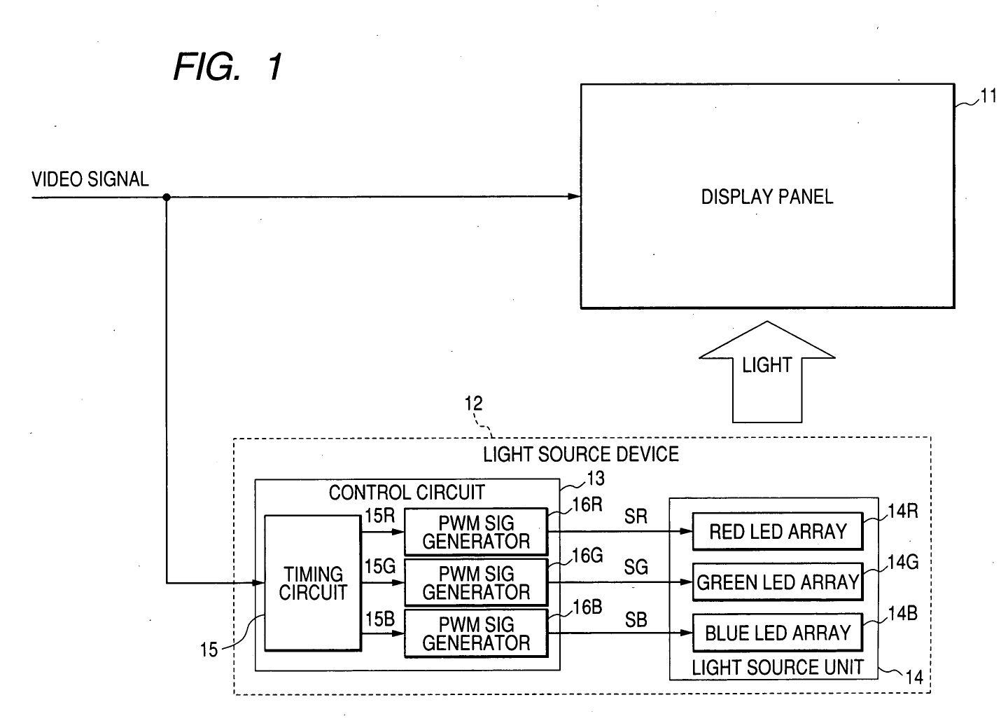

With reference to FIG. 1, a video display includes a display panel 11, and a back light device 12 for illuminating the display panel 11. The display panel 11 is, for example, a color liquid-crystal display panel having a color filter. Basically, the back light device 12 is designed to apply white light to the display panel 11. A video signal having red (R), green (G), and blue (B) signals and vertical and horizontal sync signals is fed to the display panel 11 and the back light device 12.

The back light device 12 includes a control circuit 13 and a light source unit 14. The control circuit 13 has a timing circuit 15 and PWM (pulse-width modulation) signal generators 16R, 16G, and 16B. The light source unit 14 has an array 14R of red LEDs (light emitting diodes), an array 14G of green LEDs, and an array 14B of blue LEDs. Preferably, the red, green, and blue LED arrays 14R, 14G, and 14B are equal in total LED number. Alternatively, the red, green, and blue LED arrays 14R, 14G, and 14B may be different in total LED number.

The timing circuit 15 in the control circuit 13 receives the video signal. The timing circuit 15 includes a sync detector or a sync separator for detecting the vertical sync signal in the video signal, and signal generators for producing timing signal 15R, 15G, and 15B in response to the detected vertical sync signal. Preferably, adjustable signal delay sections are provided in the connections of the sync detector (or the sync separator) with the signal generators respectively. The produced timing signals 15R, 15G, and 15B are synchronized with the vertical sync signal. In other words, the timing signals 15R, 15G, and 15B are synchronized with frames represented by the video signal. The timing circuit 15 outputs the timing signals 15R, 15G, and 15B to the PWM signal generators 16R, 16G, and 16B respectively.

The PWM signal generators 16R, 16G, and 16B are assigned to the red LED array 14R, the green LED array 14G, and the blue LED array 14B in the light source unit 14, respectively. The PWM signal generator 16R produces a PWM signal SR in response to the timing signal 15R. The produced PWM signal SR has a specified phase relation with the timing signal 15R or the vertical sync signal. Preferably, the PWM signal SR has a duty cycle less than 100%. The PWM signal generator 16G produces a PWM signal SG in response to the timing signal 15G. The produced PWM signal SG has a specified phase relation with the timing signal SG or the vertical sync signal. Preferably, the PWM signal SG has a duty cycle less than 100%. The PWM signal generator 16B produces a PWM signal SB in response to the timing signal 15B. The produced PWM signal SB has a specified phase relation with the timing signal 15B or the vertical sync signal. Preferably, the PWM signal SB has a duty cycle less than 100%. The PWM signal generators 16R, 16G, and 16B feed the PWM signals SR, SG, and SB to the red LED array 14R, the green LED array 14G, and the blue LED array 14B, respectively.

The red LED array 14R emits red light while being driven by the PWM signal SR. The green LED array 14G emits green light while being driven by the PWM signal SG. The blue LED array 14B emits blue light while being driven by the PWM signal SB. Basically, the emitted red light, the emitted green light, and the emitted blue light mix with each other, constituting white light applied to the display panel 11.

The PWM signal SR alternates between a high level state and a low level state. The red LED array 14R is activated and deactivated when the PWM signal SR is in its high level state and its low level state, respectively. The red LED array 14R emits the red light only when being activated. Thus, every positive-going pulse in the PWM signal SR serves as a drive pulse for the red LED array 14R. The PWM signal SG alternates between a high level state and a low level state. The green LED array 14G is activated and deactivated when the PWM signal SG is in its high level state and its low level state, respectively. The green LED array 14G emits the green light only when being activated. Thus, every positive-going pulse in the PWM signal SG serves as a drive pulse for the green LED array 14G. The PWM signal SB alternates between a high level state and a low level state. The blue LED array 14B is activated and deactivated when the PWM signal SB is in its high level state and its low level state, respectively. The blue LED array 14B emits the blue light only when being activated. Thus, every positive-going pulse in the PWM signal SB serves as a drive pulse for the blue LED array 14B.

The time position of every drive pulse in the PWM signal SR relative to the vertical sync signal, and the width thereof are determined by the timing signal 15R. Accordingly, the timing and duration of every activation of the red LED array 14R are determined by the timing signal 15R. The time position of every drive pulse in the PWM signal SG relative to the vertical sync signal, and the width thereof are determined by the timing signal 15G. Accordingly, the timing and duration of every activation of the green LED array 14G are determined by the timing signal 15G. The time position of every drive pulse in the PWM signal SB relative to the vertical sync signal, and the width thereof are determined by the timing signal 15B. Accordingly, the timing and duration of every activation of the blue LED array 14B are determined by the timing signal 15B.

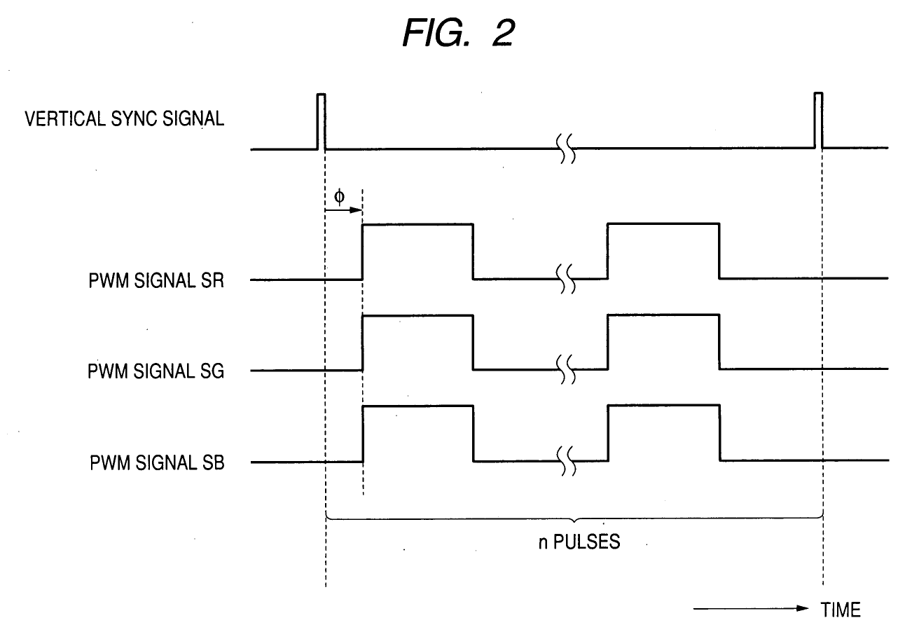

FIG. 2 shows a first example of the waveforms of the vertical sync signal and the PWM signals SR, SG, and SB, and the phase relation thereamong. In FIG. 2, each of the PWM signals SR, SG, and SB has “n” positive-going pulse or pulses (drive pulse or pulses) during every 1-frame time interval defined by the vertical sync signal, where “n” denotes an integer equal to or greater than “1”. The PWM signals SR,SG, and SB are the same in waveform, pulse frequency, and PWM period. The PWM signals SR, SG, and SB have equal phases “φ” relative to the vertical sync signal. Every positive-going pulse in the PWM signal SR and those in the PWM signals SG and SB are equal in timing and width.

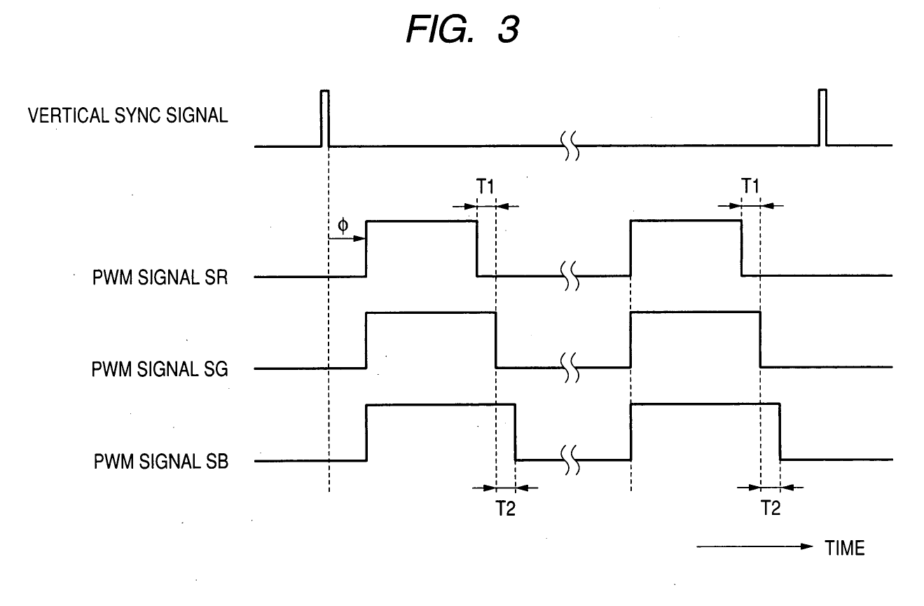

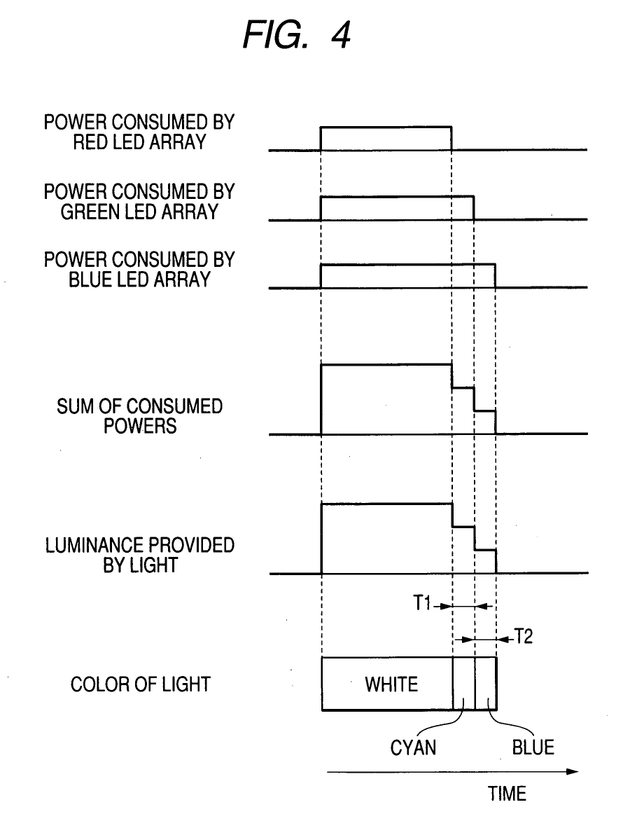

FIG. 3 shows a second example of the waveforms of the vertical sync signal and the PWM signals SR, SG, and SB, and the phase relation thereamong for use with, for example, non-field sequential drive or impulse drive of the display panel 11. The impulse drive is of not only a true type but also a pseudo type based on back light control. FIG. 4 shows time-domain variations in the electric powers consumed by the red, green, and blue LED arrays 14R, 14G, and 14B, the sum of the consumed electric powers, the luminance provided by the light applied from the back light device 12 to the display panel 11, and the color of the light applied from the back light device 12 to the display panel 11 which occur in the case where the waveforms of the vertical sync signal and the PWM signals SR, SG, and SB, and the phase relation thereamong are in the conditions of FIG. 3.

With reference to FIGS. 3 and 4, each of the PWM signals SR, SG, and SB has one or more positive-going pulses (drive pulses) during every 1-frame time interval defined by the vertical sync signal. The PWM signals SR, SG, and SB are the same in pulse frequency and PWM period. The PWM signals SR, SG, and SB have equal phases “φ” relative to the vertical sync signal. Every positive-going pulse in the PWM signal SR and those in the PWM signals SG and SB are equal in rising-edge timing. Every positive-going pulse in the PWM signal SR and those in the PWM signals SG and SB are different in falling-edge timing. Thus, every positive-going pulse in the PWM signal SR and those in the PWM signals SG and SB are different in width. Specifically, the time position of the falling edge of every positive-going pulse in the PWM signal SG is later than that of the falling edge of a corresponding positive-going pulse in the PWM signal SR by a time interval T1. The time position of the falling edge of every positive-going pulse in the PWM signal SB is later than that of the falling edge of a corresponding positive-going pulse in the PWM signal SG by a time interval T2. Therefore, every positive-going pulse in the PWM signal SG is wider than a corresponding positive-going pulse in the PWM signal SR by the time interval T1. Every positive-going pulse in the PWM signal SB is wider than a corresponding positive-going pulse in the PWM signal SG by the time interval T2. The waveforms of the vertical sync signal and the PWM signals SR, SG, and SB, and the phase relation thereamong in FIG. 3 are to compensate for differences in light emission efficiency among red, green, and blue LEDs.

Under the signal conditions of FIG. 3, the timings of start of the corresponding light emissions from the red, green, and blue LED arrays 14R, 14G, and 14B are the same. On the other hand, the timings of end of the corresponding light emissions from the red, green, and blue LED arrays 14R, 14G, and 14B are different. Specifically, the light emission from the green LED array 14G terminates the time interval T1 after the end of the corresponding light emission from the red LED array 14R. The light emission from the green LED array 14G continues until the time interval T1 has lapsed since the moment of end of the corresponding light emission from the red LED array 14R. The light emission from the blue LED array 14B terminates the time interval T2 after the end of the corresponding light emission from the green LED array 14G. The light emission from the blue LED array 14B continues until the time interval T2 has lapsed since the moment of end of the corresponding light emission from the green LED array 14G. Thus, for the time intervals T1 and T2, the light emission from the blue LED array 14B lasts. During the time interval T1, the red light is absent so that the color of the light applied from the back light device 12 to the display panel I1 is cyan as shown in FIG. 4. During the time interval T2, the red light and the green light are absent so that the color of the light applied from the back light device 12 to the display panel 11 is blue as shown in FIG. 4. In general, as the time intervals T1 and T2 are longer, color breaking in an image indicated by the display panel 11 is more observable.

With reference to FIGS. 3 and 4, the timings of start of the corresponding light emissions from the red, green, and blue LED arrays 14R, 14G, and 14B are the same so that the sum of the electric powers consumed by the red, green, and blue LED arrays 14R, 14G, and 14B instantly takes the maximum value at that timing. Therefore, the maximum load is instantly applied to a power supply for the red, green, and blue LED arrays 14R, 14G, and 14B. Such an instantly-applied maximum load may damage the power supply or shorten the life thereof. During the time intervals T1 and T2, the luminance provided by the light applied from the back light device 12 to the display panel 11 has appreciable values and hence after-light exists so that an after-image may be indicated by the display panel 11. The after-light or the indicated after-image may cancel the advantage provided by the impulse drive of the display panel 11.

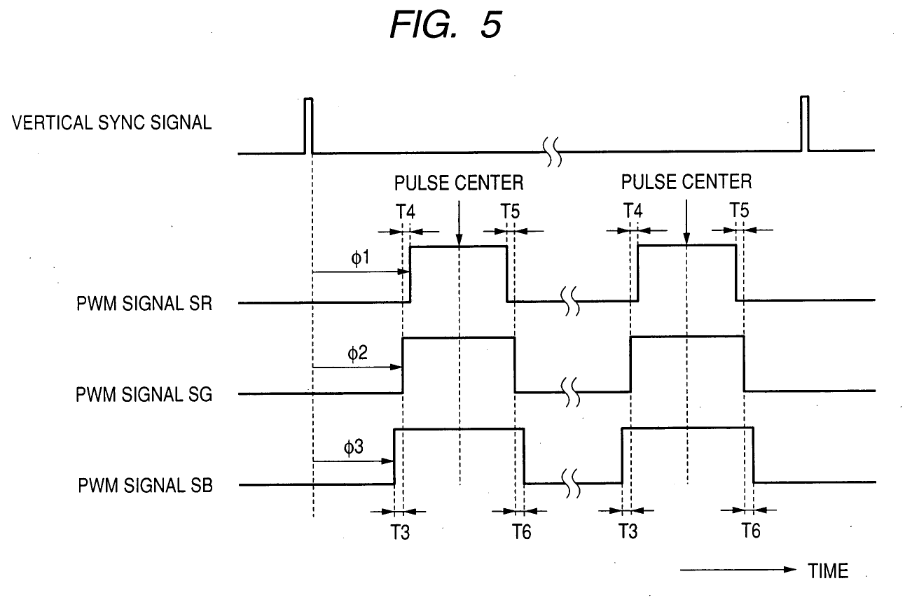

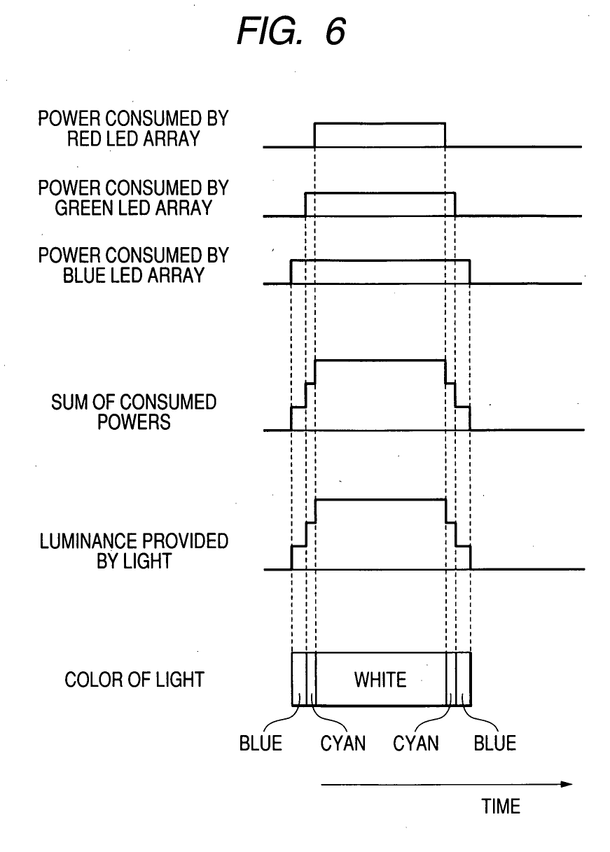

FIG. 5 shows a third example of the waveforms of the vertical sync signal and the PWM signals SR, SG, and SB, and the phase relation thereamong for use with, for example, non-field sequential drive or impulse drive of the display panel 11. FIG. 6 shows time-domain variations in the electric powers consumed by the red, green, and blue LED arrays 14R, 14G, and 14B, the sum of the consumed electric powers, the luminance provided by the light applied from the back light device 12 to the display panel 11, and the color of the light applied from the back light device 12 to the display panel 11 which occur in the case where the waveforms of the vertical sync signal and the PWM signals SR, SG, and SB, and the phase relation thereamong are in the conditions of FIG. 5.

With reference to FIGS. 5 and 6, each of the PWM signals SR, SG, and SB has one or more positive-going pulses (drive pulses) during every 1-frame time interval defined by the vertical sync signal. The PWM signals SR, SG, and SB are the same in pulse frequency and PWM period. The PWM signals SR, SG, and SB have different phases φ1, φ2, and φ3 relative to the vertical sync signal. Every positive-going pulse in the PWM signal SR and those in the PWM signals SG and SB are different in rising-edge timing and falling-edge timing. The time positions of the centers of corresponding positive-going pulses in the PWM signals SR, SG, and SB are the same. Thus, every positive-going pulse in the PWM signal SR and those in the PWM signals SG and SB are different in width. Specifically, the time position of the rising edge of every positive-going pulse in the PWM signal SG is later than that of the rising edge of a corresponding positive-going pulse in the PWM signal SB by a time interval T3. The time position of the rising edge of every positive-going pulse in the PWM signal SR is later than that of the rising edge of a corresponding positive-going pulse in the PWM signal SG by a time interval T4. The time position of the falling edge of every positive-going pulse in the PWM signal SG is later than that of the falling edge of a corresponding positive-going pulse in the PWM signal SR by a time interval T5. The time position of the falling edge of every positive-going pulse in the PWM signal SB is later than that of the falling edge of a corresponding positive-going pulse in the PWM signal SG by a time interval T6. Therefore, every positive-going pulse in the PWM signal SG is wider than a corresponding positive-going pulse in the PWM signal SR by the sum of the time intervals T4 and T5. Every positive-going pulse in the PWM signal SB is wider than a corresponding positive-going pulse in the PWM signal SG by the sum of the time intervals T3 and T6. Every positive-going pulse in the PWM signal SR occupies a time range contained in a time range for which a corresponding positive-going pulse in the PWM signal SB extends. Similarly, every positive-going pulse in the PWM signal SG occupies a time range contained in a time range for which a corresponding positive-going pulse in the PWM signal SB extends. Thus, it is possible to maximize the length of every term during which all the red, green, and blue LED arrays 14R, 14G, and 14B are deactivated. This term-length maximization promotes the advantage provided by the impulse drive of the display panel 11. The waveforms of the vertical sync signal and the PWM signals SR, SG, and SB, and the phase relation thereamong in FIG. 5 are to compensate for differences in light emission efficiency among red, green, and blue LEDs.

Under the signal conditions of FIG. 5, the timings of start of the corresponding light emissions from the red, green, and blue LED arrays 14R, 14G, and 14B are different. Furthermore, the timings of end of the corresponding light emissions from the red, green, and blue LED arrays 14R, 14G, and 14B are different. Specifically, the light emission from the blue LED array 14B starts the time interval T3 before the start of the corresponding light emission from the green LED array 14G. The light emission from the green LED array 14G starts the time interval T4 before the start of the corresponding light emission from the red LED array 14R. For the time interval T3, the light emission from the blue LED array 14B lasts. For the time interval T4, the light emissions from the green and blue LED arrays 14G and 14B last. Therefore, during the time interval T3, the red light and the green light are absent so that the color of the light applied from the back light device 12 to the display panel 11 is blue as shown in FIG. 6. During the time interval T4, the red light is absent so that the color of the light applied from the back light device 12 to the display panel 11 is cyan as shown in FIG. 6. The light emission from the green LED array 14G terminates the time interval T5 after the end of the corresponding light emission from the red LED array 14R. The light emission from the green LED array 14G continues until the time interval T5 has lapsed since the moment of end of the corresponding light emission from the red LED array 14R. The light emission from the blue LED array 14B terminates the time interval T6 after the end of the corresponding light emission from the green LED array 14G. The light emission from the blue LED array 14B continues until the time interval T6 has lapsed since the moment of end of the corresponding light emission from the green LED array 14G. Thus, for the time intervals T5 and T6, the light emission from the blue LED array 14B lasts. During the time interval T5, the red light is absent so that the color of the light applied from the back light device 12 to the display panel 11 is cyan as shown in FIG. 6. During the time interval T6, the red light and the green light are absent so that the color of the light applied from the back light device 12 to the display panel 11 is blue as shown in FIG. 6. It is thought that the time interval T1 in FIG. 3 is halved into the time intervals T4 and T5 in FIG. 5, and that the time interval T2 in FIG. 3 is halved into the time intervals T3 and T6 in FIG. 5.

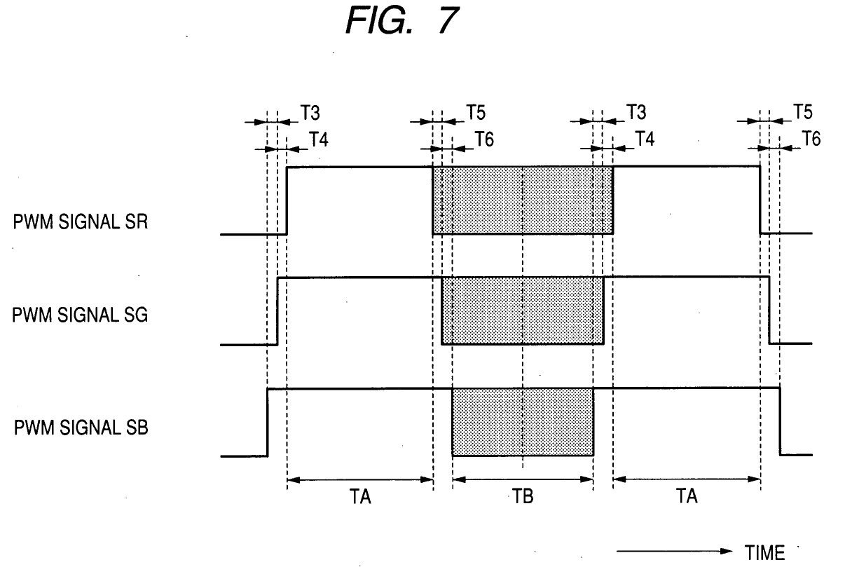

As shown in FIG. 7, there are full activation time ranges TA and full deactivation time ranges TB. The full activation time range TA means a term during which all the red, green, and blue LED arrays 14R, 14G, and 14B are activated so that all the red light, the green light, and the blue light are present. The full deactivation time range TB means a term during which all the red, green, and blue LED arrays 14R, 14G, and 14B are deactivated so that all the red light, the green light, and the blue light are absent. There is a full activation time range TA or a full deactivation time range TB between the neighboring time intervals T4 and T5. Similarly, there is a full activation time range TA or a full deactivation time range TB between the neighboring time intervals T3 and T6. Therefore, the time intervals T4 and T5 are recognized as separate ones. Similarly, the time intervals T3 and T6 are recognized as separate ones. Accordingly, during the time intervals T3, T4, T5, and T6, color breaking in an image indicated by the display panel 11 is less observable.

With reference to FIGS. 5-7, the timings of start of the corresponding light emissions from the red, green, and blue LED arrays 14R, 14G, and 14B are different so that the sum of the electric powers consumed by the red, green, and blue LED arrays 14R, 14G, and 14B gradually increases to the maximum value. Therefore, the load applied to the power supply for the red, green, and blue LED arrays 14R, 14G, and 14B gradually increases to the maximum level. Basically, such a gradually-increasing applied load is acceptable to the power supply. As previously mentioned, the time interval T1 in FIG. 3 is halved into the time intervals T4 and T5 in FIG. 5, and the time interval T2 in FIG. 3 is halved into the time intervals T3 and T6 in FIG. 5. There is a full activation time range TA or a full deactivation time range TB between the neighboring time intervals T4 and T5. Similarly, there is a full activation time range TA or a full deactivation time range TB between the neighboring time intervals T3 and T6. Accordingly, after-light exists only for shorter time intervals (the time intervals T5 and T6). Therefore, it is possible to enhance the quality of moving pictures indicated by the display panel 11 even in the case of the impulse drive of the display panel 11.

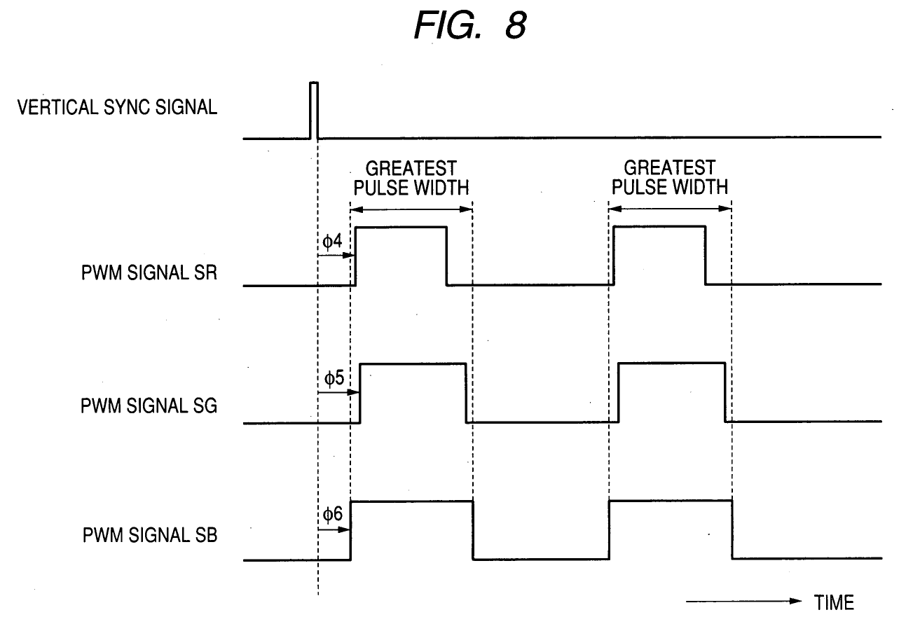

FIG. 8 shows a fourth example of the waveforms of the vertical sync signal and the PWM signals SR, SG, and SB, and the phase relation thereamong for use with, for example, non-field sequential drive or impulse drive of the display panel 11.

With reference to FIG. 8, the PWM signal SB is a reference for designing and setting the PWM signals SR and SG. Each of the PWM signals SR, SG, and SB has one or more positive-going pulses (drive pulses) during every 1-frame time interval defined by the vertical sync signal. The PWM signals SR, SG, and SB are the same in pulse frequency and PWM period. The PWM signals SR, SG, and SB have different phases φ4, φ5, and φ6 relative to the vertical sync signal. Every positive-going pulse in the PWM signal SR and those in the PWM signals SG and SB are different in rising-edge timing, falling-edge timing, and width. Specifically, the time position of the rising edge of every positive-going pulse in the PWM signal SR is later than that of the rising edge of a corresponding positive-going pulse in the PWM signal SB. The time position of the rising edge of every positive-going pulse in the PWM signal SG is later than that of the rising edge of a corresponding positive-going pulse in the PWM signal SR. The time position of the falling edge of every positive-going pulse in the PWM signal SG is later than that of the falling edge of a corresponding positive-going pulse in the PWM signal SR. The time position of the falling edge of every positive-going pulse in the PWM signal SB is later than that of the falling edge of a corresponding positive-going pulse in the PWM signal SG. Every positive-going pulse in the PWM signal SG is wider than a corresponding positive-going pulse in the PWM signal SR. Every positive-going pulse in the PWM signal SB is wider than a corresponding positive-going pulse in the PWM signal SG. Every positive-going pulse in the PWM signal SR occupies a time range contained in a time range for which a corresponding positive-going pulse in the PWM signal SB extends. Similarly, every positive-going pulse in the PWM signal SG occupies a time range contained in a time range for which a corresponding positive-going pulse in the PWM signal SB extends. Thus, it is possible to maximize the length of every term during which all the red, green, and blue LED arrays 14R, 14G, and 14B are deactivated. This term-length maximization promotes the advantage provided by the impulse drive of the display panel 11. The waveforms of the vertical sync signal and the PWM signals SR, SG, and SB, and the phase relation thereamong in FIG. 8 are to compensate for differences in light emission efficiency among red, green, and blue LEDs.

When the vertical sync signal and the PWM signals SR, SG, and SB are in the conditions of FIG. 8, the timings of start of the corresponding light emissions from the red, green, and blue LED arrays 14R, 14G, and 14B are different. Furthermore, the timings of end of the corresponding light emissions from the red, green, and blue LED arrays 14R, 14G, and 14B are different. Specifically, the light emission from the blue LED array 14B starts before the start of the corresponding light emission from the red LED array 14R. The light emission from the red LED array 14R starts before the start of the corresponding light emission from the green LED array 14G. The light emission from the green LED array 14G terminates after the end of the corresponding light emission from the red LED array 14R. The light emission from the blue LED array 14B terminates after the end of the corresponding light emission from the green LED array 14G. It is thought that the time interval T1 in FIG. 3 is divided into separate portions, and that the time interval T2 in FIG. 3 is divided into separate portions. Accordingly, color breaking in an image indicated by the display panel 11 is less observable. Since the timings of start of the corresponding light emissions from the red, green, and blue LED arrays 14R, 14G, and 14B are different, the sum of the electric powers consumed by the red, green, and blue LED arrays 14R, 14G, and 14B gradually increases to the maximum value. Therefore, the load applied to the power supply for the red, green, and blue LED arrays 14R, 14G, and 14B gradually increases to the maximum level. Basically, such a gradually-increasing applied load is acceptable to the power supply.

### Second Embodiment

A second embodiment of this invention is similar to the first embodiment thereof except that one or two of the red, green, and blue LED arrays 14R, 14G, and 14B are omitted.

### Third Embodiment

A third embodiment of this invention is similar to the first embodiment thereof except that an LED array or arrays for emitting light having a color or colors different from red, green, and blue are added.

### Fourth Embodiment

A fourth embodiment of this invention is similar to the first embodiment thereof except that the PWM signal SR is wider in drive pulse width than the PWM signals SG and SB.

### Fifth Embodiment

A fifth embodiment of this invention is similar to the first embodiment thereof except that the PWM signal SG is wider in drive pulse width than the PWM signals SR and SB.

### Sixth Embodiment

A sixth embodiment of this invention is similar to the first embodiment thereof except that the red, green, and blue LED arrays 14R, 14G, and 14B are replaced by red, green, and blue light sources exclusive of LEDs.

What is claimed is:

1. A method of driving a light source device for a video display, the light source device including a first light source for emitting light having a first primary color, a second light source for emitting light having a second primary color different from the first primary color, and a third light source for emitting light having a third primary color different from the first and second primary colors, the method comprising the steps of:
activating the first light source by a first drive pulse which has a first width and which repetitively occurs at a specified frequency;
activating the second light source by a second drive pulse which has a second width and which repetitively occurs at the specified frequency; and
activating the third light source by a third drive pulse which has a third width greater than the first and second widths and which repetitively occurs at the specified frequency;
wherein time positions of front edges of the first, second, and third drive pulses are different, and wherein the first drive pulse occupies a time range contained in a time range for which the third drive pulse extends, and the second drive pulse occupies a time range contained in the time range for which the third drive pulse extends.

2. A method as recited in claim 1, wherein time positions of centers of the first, second, and third drive pulses are equal.

3. A method as recited in claim 1, wherein time positions of rear edges of the first, second, and third drive pulses are different.

4. A light source device for a video display, comprising:
a first light source for emitting light having a first primary color;
a second light source for emitting light having a second primary color different from the first primary color;
a third light source for emitting light having a third primary color different from the first and second primary colors;
means for activating the first light source by a first drive pulse which has a first width and which repetitively occurs at a specified frequency;
means for activating the second light source by a second drive pulse which has a second width and which repetitively occurs at the specified frequency; and
means for activating the third light source by a third drive pulse which has a third width greater than the first and second widths and which repetitively occurs at the specified frequency;
wherein time positions of front edges of the first, second, and third drive pulses are different, and wherein the first drive pulse occupies a time range contained in a time range for which the third drive pulse extends, and the second drive pulse occupies a time range contained in the time range for which the third drive pulse extends.

5. A light source device as recited in claim 4, wherein time positions of centers of the first, second, and third drive pulses are equal.

6. A light source device as recited in claim 4, wherein time positions of rear edges of the first, second, and third drive pulses are different.

7. A light source device as recited in claim 4, wherein each of the first, second, and third light sources comprises an array of LEDs.

8. A method of driving a back light device for a liquid-crystal display, the back light device including a first light source for emitting light having a first color, and a second light source for emitting light having a second color different from the first color, the method comprising the steps of:
activating the first light source by a first drive pulse which has a first width and which repetitively occurs at a specified frequency; and
activating the second light source by a second drive pulse which has a second width greater than the first width and which repetitively occurs at the specified frequency;
wherein time positions of front edges of the first and second drive pulses are different, and time positions of rear edges of the first and second drive pulses are different, and wherein the first drive pulse occupies a time range contained in a time range for which the second drive pulse extends.

9. A method as recited in claim 8, wherein each of the first and second light sources comprises an array of LEDs.

10. A method as recited in claim 8, wherein time positions of centers of the first and second drive pulses are equal.

11. A back light device for a liquid-crystal display, comprising:
a first light source for emitting light having a first color;
a second light source for emitting light having a second color different from the first color;
means for activating the first light source by a first drive pulse which has a first width and which repetitively occurs at a specified frequency; and
means for activating the second light source by a second drive pulse which has a second width greater than the first width and which repetitively occurs at the specified frequency;
wherein time positions of front edges of the first and second drive pulses are different, and time positions of rear edges of the first and second drive pulses are different, and wherein the first drive pulse occupies a time range contained in a time range for which the second drive pulse extends.

12. A back light device as recited in claim 11, wherein each of the first and second light sources comprises an array of LEDs.

13. A back light device as recited in claim 11, wherein time positions of centers of the first and second drive pulses are equal.
